(19) United States
(12) Patent Application Publication
(10) Pub. No.: US 2024/0171762 A1
(43) Pub. Date: May 23, 2024

(54) System, Method, and Computer Program Product for Video Encoding for Autonomous Vehicles

(71) Applicant: Argo AI, LLC, Pittsburgh, PA (US)

(72) Inventors: Florian Netter, Ingolstadt (DE); Jonathan Michael Bonte, Farmington Hills, MI (US); Kevin Nealis, Yardley, PA (US)

(21) Appl. No.: 17/992,153

(22) Filed: Nov. 22, 2022

(51) Int. Cl. H04N 19/423; B60W 60/00; H04N 19/136; H04N 19/436

(52) U.S. Cl. CPC H04N 19/423; B60W 60/001; H04N 19/136; H04N 19/436; H04N 9/64

(57) ABSTRACT

Systems, methods, and computer-program products for video encoding for autonomous vehicles are disclosed. A method for video encoding for autonomous vehicles may include receiving image data associated with a plurality of images from at least one camera of an autonomous vehicle. The image data may be encoded into a plurality of video streams including at least one first video stream and at least one second video stream. The at least one first video stream may be associated with a first quality level. The at least one second video stream may be associated with a second quality level different than the first quality level. At least one of the plurality of video streams may be communicated to at least one data storage device.

### BACKGROUND

### 1. Field

This disclosed subject matter relates generally to systems, methods, and computer program products for video encoding and, in some non-limiting embodiments or aspects, to a system, method, and computer program product for video encoding for autonomous vehicles.

### 2. Technical Considerations

Autonomous vehicles rely on various sensors that operate to gather information about an environment in which the vehicle is operating and/or traveling. For example, autonomous vehicles may rely on one or more cameras (e.g., multiple cameras) to capture images of the environment.

However, captured images (e.g., from high resolution cameras and/or from multiple cameras) may include a very large amount of data, which can result in multiple difficulties. For example, uncompressed images may include such a large amount of data that a very large amount of data storage resources would be required and/or the amount of data may exceed the capacity of data storage resources of reasonable size for being included on board an autonomous vehicle. Additionally, uncompressed images (or even high quality (e.g., high resolution, high bit rate, high frame rate, low compression ratio, high quality color/chroma format, etc.) compressed video streams) may be too large for suitable transmission over certain wireless networks (e.g., a cellular network and/or the like), for example, during operation of the autonomous vehicle. Moreover, captured images (e.g., from high resolution cameras and/or from multiple cameras) may include such a large amount of data that certain encoders do not have sufficient throughput to process (e.g., compress and/or store) one or more video streams based on the captured images, for example, in real time during operation of the autonomous vehicle. Even if an encoder may have sufficient throughput to process a single video stream, such an encoder may not have sufficient throughput to process multiple video streams (e.g., of different quality levels for different applications related to the autonomous vehicle). Furthermore, certain encoders may not meet other tolerance demands of an autonomous vehicle, such as noise tolerance, heat tolerance, multiple input/output interfaces (e.g., of different types), access of debugging information, power consumption, software-based configurability, and/or the like.

### SUMMARY

Accordingly, it is an object of the presently disclosed subject matter to provide systems and methods for video encoding for autonomous vehicles (e.g., to facilitate autonomous driving operations, simulations thereof, logging thereof, and/or machine learning based thereon) that overcome some or all of the deficiencies identified above.

According to non-limiting embodiments or aspects, provided is a method for video encoding for autonomous vehicles. The method for video encoding for autonomous vehicles may include receiving image data associated with a plurality of images from at least one camera of an autonomous vehicle. The image data may be encoded into a plurality of video streams including at least one first video stream and at least one second video stream. The at least one first video stream may be associated with a first quality level. The at least one second video stream may be associated with a second quality level different than the first quality level. At least one of the plurality of video streams may be communicated to at least one data storage device.

In some non-limiting embodiments or aspects, the at least one camera may include at least one near field camera and at least one far field camera. Receiving the image data may include receiving, with at least one first image signal processor (ISP), first image data from each respective far field camera of the at least one far field camera. The at least one first ISP may communicated the first image data from each respective far field camera to at least one graphics processor. At least one second ISP may receive second image data from each respective near field camera of the at least one near field camera. The at least one second ISP may communicated the second image data from each respective near field camera to the at least one graphics processor. The at least one graphics processor may preprocess at least one of the first image data, the second image data, or any combination thereof to form the image data. The at least one graphics processor may communicate the image data to the at least one processor.

In some non-limiting embodiments or aspects, preprocessing may include at least one of: reducing, with the at least one graphics processor, a resolution of the at least one of the first image data, the second image data, or any combination thereof; modifying, with the at least one graphics processor, a color format of the at least one of the first image data, the second image data, or any combination thereof; or any combination thereof.

In some non-limiting embodiments or aspects, the at least one camera may include a first camera and a second camera. The image data may include first image data associated with a first plurality of images from the first camera and second image data associated with a second plurality of images from the second camera. Receiving the image data may include receiving the first image data associated with a first image of the first plurality of images from the first camera. The first image data associated with the first image may be stored in a data storage device. The second image data associated with a second image of the second plurality of images from the second camera may be received after receiving the first image data associated with the first image. The second image data associated with the second image may be stored in the data storage device. Encoding may include encoding the first image data associated with the first image before encoding the second image data associated with the second image.

In some non-limiting embodiments or aspects, encoding may include encoding the image data into the plurality of video streams in real time during operation of the autonomous vehicle.

In some non-limiting embodiments or aspects, encoding may include encoding the image data into the plurality of video streams substantially simultaneously.

In some non-limiting embodiments or aspects, the at least one processor may include a plurality of hardware encoders comprising a first hardware encoder and a second hardware encoder.

In some non-limiting embodiments or aspects, encoding the image data may include encoding the image data into the at least one first video stream with the first hardware encoder and encoding the image data into the at least one second video stream with the second hardware encoder.

In some non-limiting embodiments or aspects, the first hardware encoder may encode the image data into the first video stream independent of the second hardware encoder encoding the image data into the at least one second video stream.

In some non-limiting embodiments or aspects, the first hardware encoder may include a first software-configurable hardware encoder and/or the second hardware encoder may include a second software-configurable hardware encoder. The first software-configurable hardware encoder may encode the image data into one of the at least one first video stream or the at least one second video stream based on a first software configuration of the first software-configurable hardware encoder. Additionally or alternatively, the second software-configurable hardware encoder may encode the image data into one of the at least one first video stream or the at least one second video stream based on a second software configuration of the second software-configurable hardware encoder.

In some non-limiting embodiments or aspects, communicating the at least one of the plurality of video streams to the at least one data storage device may include communicating the at least one of the plurality of video streams to a central processing unit, and the central processing unit may store the at least one of the plurality of video streams in the at least one data storage device.

In some non-limiting embodiments or aspects, communicating the at least one of the plurality of video streams to the at least one data storage device may include storing the at least one first video stream in a first data storage device of the autonomous vehicle. Additionally or alternatively, communicating the at least one of the plurality of video streams to the at least one data storage device may include communicating the at least one second video stream to a remote system via a communication network during operation of the autonomous vehicle, and the remote system may store the at least one second video stream in a second data storage device of the remote system. In some non-limiting embodiments or aspects, communicating the at least one of the plurality of video streams to the at least one data storage device may further include communicating the at least one first video stream from the first data storage device to the remote system after ceasing operation of the autonomous vehicle.

In some non-limiting embodiments or aspects, at least one autonomous driving operation of the autonomous vehicle may be facilitated based on the at least one of the plurality of video streams.

According to non-limiting embodiments or aspects, provided is a system for video encoding for autonomous vehicles. The system for video encoding for autonomous vehicles may include at least one camera of an autonomous vehicle and an encoder device. The encoder device may be configured to receive image data associated with a plurality of images from the at least one camera. The encoder device may be configured to encode the image data into a plurality of video streams comprising at least one first video stream and at least one second video stream. The at least one first video stream may be associated with a first quality level, and/or the at least one second video stream may be associated with a second quality level different than the first quality level. The encoder device may be configured to communicate at least one of the plurality of video streams to at least one data storage device.

In some non-limiting embodiments or aspects, the at least one camera may include at least one near field camera and at least one far field camera. The system may further include at least one graphics processor, at least one first ISP configured to receive first image data from each respective far field camera of the at least one far field camera and communicate the first image data from each respective far field camera to the at least one graphics processor, and at least one second ISP configured to receive second image data from each respective near field camera of the at least one near field camera and communicate the second image data from each respective near field camera to the at least one graphics processor. In some non-limiting embodiments or aspects, the at least one graphics processor may be configured to preprocess at least one of the first image data, the second image data, or any combination thereof to form the image data and communicate the image data to the encoder device. In some non-limiting embodiments or aspects, preprocessing may include at least one of: reducing, with the at least one graphics processor, a resolution of the at least one of the first image data, the second image data, or any combination thereof; modifying, with the at least one graphics processor, a color format of the at least one of the first image data, the second image data, or any combination thereof; or any combination thereof.

In some non-limiting embodiments or aspects, the at least one camera may include a first camera and a second camera. The image data may include first image data associated with a first plurality of images from the first camera and second image data associated with a second plurality of images from the second camera. In some non-limiting embodiments or aspects, the encoder device may further include a data storage device configured to store the first image data associated with a first image of the first plurality of images from the first camera and store the second image data associated with a second image of the second plurality of images from the second camera after receiving the first image data associated with the first image. In some non-limiting embodiments or aspects, the encoder device may be configured to encode the first image data associated with the first image before encoding the second image data associated with the second image.

In some non-limiting embodiments or aspects, the system may further include a computing device of the autonomous vehicle. The computing device may include a central processing unit and a data storage device. When communicating the at least one of the plurality of video streams to the at least one data storage device, the encoder device may be configured to communicate the at least one of the plurality of video streams to the central processing unit, and the central processing unit may be configured to store the at least one of the plurality of video streams in the data storage device.

In some non-limiting embodiments or aspects, when communicating the at least one of the plurality of video streams to the at least one data storage device, the encoder device may be configured to store the at least one first video stream in a first data storage device of the autonomous vehicle. Additionally or alternatively, when communicating the at least one of the plurality of video streams to the at least one data storage device, the encoder device may be configured to communicate the at least one second video stream to a remote system via a communication network during operation of the autonomous vehicle. In some non-limiting embodiments or aspects, the remote system may store the at least one second video stream in a second data storage device of the remote system.

According to non-limiting embodiments or aspects, provided is a computer program product for video encoding for autonomous vehicles. The computer program product for video encoding for autonomous vehicles may include at least one non-transitory computer-readable medium including one or more instructions that, when executed by at least one processor, cause the at least one processor to receive image data associated with a plurality of images from at least one camera of an autonomous vehicle. The one or more instructions, when executed by at least one processor, may cause the at least one processor to encode the image data into a plurality of video streams comprising at least one first video stream and at least one second video stream. The at least one first video stream may be associated with a first quality level, and the at least one second video stream associated with a second quality level different than the first quality level. The one or more instructions, when executed by at least one processor, may cause the at least one processor to communicate at least one of the plurality of video streams to at least one data storage device.

According to non-limiting embodiments or aspects, provided is a device for video encoding for autonomous vehicles. The device for video encoding for autonomous vehicles may include at least one connector configured to receive image data associated with a plurality of images from at least one camera of an autonomous vehicle, at least one processor coupled to the connector and configured to encode the image data into a plurality of video streams comprising at least one first video stream and at least one second video stream, and at least one network adapter coupled to the at least one processor and configured to receive at least one of the plurality of video streams from the at least one processor and to communicate the at least one of the plurality of video streams to at least one data storage device. The at least one first video stream associated with a first quality level, and the at least one second video stream associated with a second quality level different than the first quality level; and

Further embodiments or aspects are set forth in the following numbered clauses:

Clause 1: A method for video encoding for autonomous vehicles, comprising: receiving, with at least one processor, image data associated with a plurality of images from at least one camera of an autonomous vehicle; encoding, with the at least one processor, the image data into a plurality of video streams comprising at least one first video stream and at least one second video stream, the at least one first video stream associated with a first quality level, the at least one second video stream associated with a second quality level different than the first quality level; and communicating, with the at least one processor, at least one of the plurality of video streams to at least one data storage device.

Clause 2: The method of clause 1, wherein the at least one camera comprises at least one near field camera and at least one far field camera, and wherein receiving the image data comprises: receiving, with at least one first image signal processor (ISP), first image data from each respective far field camera of the at least one far field camera; communicating, with the at least one first ISP, the first image data from each respective far field camera to at least one graphics processor; receiving, with at least one second ISP, second image data from each respective near field camera of the at least one near field camera; communicating, with the at least one second ISP, the second image data from each respective near field camera to the at least one graphics processor; preprocessing, with the at least one graphics processor, at least one of the first image data, the second image data, or any combination thereof to form the image data; and communicating, by the at least one graphics processor, the image data to the at least one processor.

Clause 3: The method of any preceding clause, wherein preprocessing comprises at least one of: reducing, with the at least one graphics processor, a resolution of the at least one of the first image data, the second image data, or any combination thereof; modifying, with the at least one graphics processor, a color format of the at least one of the first image data, the second image data, or any combination thereof; or any combination thereof.

Clause 4: The method of any preceding clause, wherein the at least one camera comprises a first camera and a second camera, wherein the image data comprises first image data associated with a first plurality of images from the first camera and second image data associated with a second plurality of images from the second camera, wherein receiving the image data comprises: receiving the first image data associated with a first image of the first plurality of images from the first camera; storing the first image data associated with the first image in a data storage device; receiving the second image data associated with a second image of the second plurality of images from the second camera after receiving the first image data associated with the first image; and storing the second image data associated with the second image in the data storage device, and wherein encoding comprises encoding the first image data associated with the first image before encoding the second image data associated with the second image.

Clause 5: The method of any preceding clause, wherein encoding comprises encoding the image data into the plurality of video streams in real time during operation of the autonomous vehicle.

Clause 6: The method of any preceding clause, wherein encoding comprises encoding the image data into the plurality of video streams substantially simultaneously.

Clause 7: The method of any preceding clause, wherein the at least one processor comprises a plurality of hardware encoders comprising a first hardware encoder and a second hardware encoder.

Clause 8: The method of any preceding clause, wherein encoding the image data comprises encoding the image data into the at least one first video stream with the first hardware encoder and encoding the image data into the at least one second video stream with the second hardware encoder.

Clause 9: The method of any preceding clause, wherein the first hardware encoder encodes the image data into the first video stream independent of the second hardware encoder encoding the image data into the at least one second video stream.

Clause 10: The method of any preceding clause, wherein the first hardware encoder comprises a first software-configurable hardware encoder and the second hardware encoder comprises a second software-configurable hardware encoder, wherein the first software-configurable hardware encoder encodes the image data into one of the at least one first video stream or the at least one second video stream based on a first software configuration of the first software-configurable hardware encoder, and wherein the second software-configurable hardware encoder encodes the image data into one of the at least one first video stream or the at least one second video stream based on a second software configuration of the second software-configurable hardware encoder.

Clause 11: The method of any preceding clause, wherein communicating the at least one of the plurality of video streams to the at least one data storage device comprises: communicating, with the at least one processor, the at least one of the plurality of video streams to a central processing unit; and storing, with the central processing unit, the at least one of the plurality of video streams in the at least one data storage device.

Clause 12: The method of any preceding clause, wherein communicating the at least one of the plurality of video streams to the at least one data storage device comprises: storing, with the at least one processor, the at least one first video stream in a first data storage device of the autonomous vehicle; and communicating, with the at least one processor, the at least one second video stream to a remote system via a communication network during operation of the autonomous vehicle, wherein the remote system stores the at least one second video stream in a second data storage device of the remote system.

Clause 13: The method of any preceding clause, wherein communicating the at least one of the plurality of video streams to the at least one data storage device further comprises: communicating, with the at least one processor, the at least one first video stream from the first data storage device to the remote system after ceasing operation of the autonomous vehicle.

Clause 14: The method of any preceding clause, further comprising: facilitating at least one autonomous driving operation of the autonomous vehicle based on the at least one of the plurality of video streams.

Clause 15: A system for video encoding for autonomous vehicles, comprising: at least one camera of an autonomous vehicle; and an encoder device configured to: receive image data associated with a plurality of images from the at least one camera; encode the image data into a plurality of video streams comprising at least one first video stream and at least one second video stream, the at least one first video stream associated with a first quality level, the at least one second video stream associated with a second quality level different than the first quality level; and communicate at least one of the plurality of video streams to at least one data storage device.

Clause 16: The system of clause 15, wherein the at least one camera comprises at least one near field camera and at least one far field camera, the system further comprises: at least one graphics processor; at least one first image signal processor (ISP) configured to receive first image data from each respective far field camera of the at least one far field camera and communicate the first image data from each respective far field camera to the at least one graphics processor; and at least one second ISP configured to receive second image data from each respective near field camera of the at least one near field camera and communicate the second image data from each respective near field camera to the at least one graphics processor, wherein the at least one graphics processor is configured to preprocess at least one of the first image data, the second image data, or any combination thereof to form the image data and communicate the image data to the encoder device, wherein preprocessing comprises at least one of: reducing, with the at least one graphics processor, a resolution of the at least one of the first image data, the second image data, or any combination thereof; modifying, with the at least one graphics processor, a color format of the at least one of the first image data, the second image data, or any combination thereof; or any combination thereof.

Clause 17: The system of clause 15 or clause 16, wherein the at least one camera comprises a first camera and a second camera, wherein the image data comprises first image data associated with a first plurality of images from the first camera and second image data associated with a second plurality of images from the second camera, wherein the encoder device further comprises a data storage device configured to: store the first image data associated with a first image of the first plurality of images from the first camera; and store the second image data associated with a second image of the second plurality of images from the second camera after receiving the first image data associated with the first image, wherein the encoder device is configured to encode the first image data associated with the first image before encoding the second image data associated with the second image.

Clause 18: The system of any of clauses 15-17, further comprising a computing device of the autonomous vehicle, wherein the computing device comprises a central processing unit and a data storage device, wherein, when communicating the at least one of the plurality of video streams to the at least one data storage device, the encoder device is configured to communicate the at least one of the plurality of video streams to the central processing unit, and wherein the central processing unit is configured to store the at least one of the plurality of video streams in the data storage device.

Clause 19: The system of any of clauses 15-18, wherein, when communicating the at least one of the plurality of video streams to the at least one data storage device, the encoder device is configured to: store the at least one first video stream in a first data storage device of the autonomous vehicle; and communicate the at least one second video stream to a remote system via a communication network during operation of the autonomous vehicle, wherein the remote system stores the at least one second video stream in a second data storage device of the remote system.

Clause 20: A computer program product for video encoding for autonomous vehicles, comprising at least one non-transitory computer-readable medium comprising one or more instructions that, when executed by at least one processor, cause the at least one processor to: receive image data associated with a plurality of images from at least one camera of an autonomous vehicle; encode the image data into a plurality of video streams comprising at least one first video stream and at least one second video stream, the at least one first video stream associated with a first quality level, the at least one second video stream associated with a second quality level different than the first quality level; and communicate at least one of the plurality of video streams to at least one data storage device.

Clause 21: A device for video encoding for autonomous vehicles, comprising: at least one connector configured to receive image data associated with a plurality of images from at least one camera of an autonomous vehicle; at least one processor coupled to the connector and configured to encode the image data into a plurality of video streams comprising at least one first video stream and at least one second video stream, the at least one first video stream associated with a first quality level, the at least one second video stream associated with a second quality level different than the first quality level; and at least one network adapter coupled to the at least one processor and configured to receive at least one of the plurality of video streams from the at least one processor and to communicate the at least one of the plurality of video streams to at least one data storage device.

Clause 22: A computer program product for video encoding for autonomous vehicles, comprising at least one non-transitory computer-readable medium comprising one or more instructions that, when executed by at least one processor, cause the at least one processor to perform the method of any of clauses 1-14.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular forms of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of an exemplary system for video encoding for autonomous vehicles, according to some non-limiting embodiments or aspects of the presently disclosed subject matter;

FIG. 2 is an illustration of an illustrative architecture for a vehicle, according to some non-limiting embodiments or aspects of the presently disclosed subject matter;

FIG. 3 is an illustration of an illustrative computer system, according to some non-limiting embodiments or aspects of the presently disclosed subject matter;

FIG. 4 is a flowchart of an exemplary process for video encoding for autonomous vehicles, according to some non-limiting embodiments or aspects of the presently disclosed subject matter;

FIG. 5 is a diagram of an exemplary implementation of a system for video encoding for autonomous vehicles, according to some non-limiting embodiments or aspects of the presently disclosed subject matter; and

FIG. 6 is a diagram of an exemplary implementation of a device for video encoding for autonomous vehicles, according to some non-limiting embodiments or aspects of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and/or the like. An “autonomous vehicle” is a vehicle having a processor, programming instructions, and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “user interface” or “graphical user interface” may refer to a generated display, such as one or more graphical user interfaces (GUIs) with which a user may interact, either directly or indirectly (e.g., through a keyboard, mouse, touchscreen, etc.).

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the disclosed subject matter are directed to systems and methods for video encoding for autonomous vehicles. For example, non-limiting embodiments or aspects of the disclosed subject matter provide systems, methods, and devices for video encoding for autonomous vehicles, which may include an encoder device for receiving image data (e.g., uncompressed image data) associated with a plurality of images from at least one camera of an autonomous vehicle, encoding the image data (e.g., with multiple different hardware encoders) into a plurality of video streams of different quality levels, and communicating one or more of the video stream(s) to at least one data storage device. Such embodiments or aspects provide an encoding device with sufficient throughput to process multiple video streams of different quality levels, for example, in real time during operation of the autonomous vehicle. As such, the different video streams of different quality levels can be communicated to the appropriate data storage device(s) for different applications related to the autonomous vehicle. For example, non-limiting embodiments or aspects of the disclosed subject matter provide storing a first video stream (e.g., a higher quality video stream) in a local data storage device of the autonomous vehicle and communicating a second video stream (e.g., a lower quality video stream) to a remote system over a communication network. As such, network resources can be conserved in transmitting the lower quality video stream to the remote system (e.g., a remote guidance system, a mapping system, a tracking system tracking the location of one or more autonomous vehicles, a logging system maintaining records for potential liability, and/or the like that can operate sufficiently with the lower quality video stream) while the higher quality video stream can be preserved for applications that require the higher quality images (e.g., facilitating driving operations of the autonomous vehicle; downloading the higher quality video stream after ceasing operation of the autonomous vehicle for review, testing, use in simulations, use in training machine learning models, use in generating maps, etc.; and/or the like). Additionally or alternatively, the disclosed embodiments or aspects provide a special-purpose device for video encoding for autonomous vehicles including a connector with multiple input/output interfaces, a network adapter, and a processing device (e.g., a multi-core processor, multiple independent hardware encoders, and/or the like) dedicated to receiving image data from the camera(s) of the autonomous vehicle and encoding the image data into the multiple streams of different quality levels such that the special-purpose device can meet the throughput and communication requirements discussed above while also including components that meet other tolerance demands of an autonomous vehicle, such as noise tolerance, heat tolerance, multiple input/output interfaces (e.g., of different types), access of debugging information, power consumption, software-based configurability, and/or the like.

For the purpose of illustration, in the following description, while the presently disclosed subject matter is described with respect to systems and methods for video encoding, e.g., for autonomous vehicles, one skilled in the art will recognize that the disclosed subject matter is not limited to the illustrative embodiments or aspects. For example, the systems and methods described herein may be used with a wide variety of settings, such as video encoding in any setting in which multiple encoded video streams of different quality levels would be useful, such as robotics, object detection, computer vision, security systems, and/or the like.

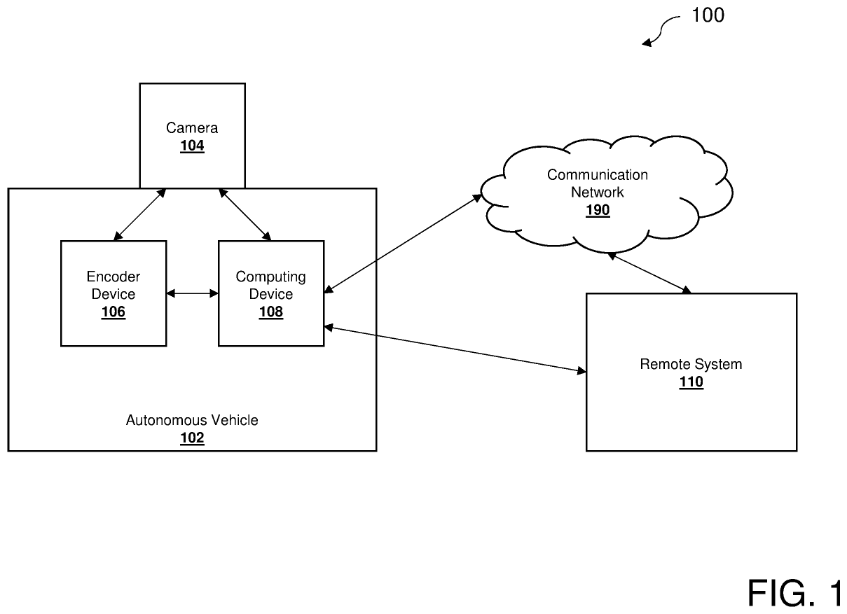

Referring now to FIG. 1, FIG. 1 is a diagram of an exemplary system 100 for video encoding for autonomous vehicles, according to some non-limiting embodiments or aspects of the presently disclosed subject matter. As shown in FIG. 1, system 100 may include autonomous vehicle 102, camera 104, encoder device 106, computing device 108, remote system 110, and/or communication network 190.

Autonomous vehicle 102 may include a vehicle, as described herein. In some non-limiting embodiments or aspects, autonomous vehicle 102 may include one or more devices (e.g., computing device 108 and/or the like) capable of receiving information from and/or communicating information to remote system 110 (e.g., directly, indirectly via communication network 190, and/or any other suitable communication technique). Additionally or alternatively, each autonomous vehicle 102 may include a device (e.g., computing device 108 and/or the like) capable of receiving information from and/or communicating information to other autonomous vehicles 102 (e.g., directly, indirectly via communication network 190, and/or any other suitable communication technique). In some non-limiting embodiments or aspects, autonomous vehicle 102 may include at least one computing device 108, such as a vehicle on-board computing device, a portable and/or handheld device (e.g., a computer, a laptop, a personal digital assistant (PDA), a smartphone, a tablet, and/or the like), a server, and/or other like devices. For example, the vehicle may include at least one computing device 108 (e.g., a vehicle on-board computing device) and at least one sensor, such as an image capture system (e.g., camera 104 and/or the like), a ray casting system (e.g., a LiDAR, a laser scanner, a radar, any combination thereof, and/or the like), any combination thereof, and/or the like, as described herein. In some non-limiting embodiments or aspects, autonomous vehicle 102 (e.g., computing device 108 thereof and/or the like) may be configured to generate map data, image data, and/or the like based on the sensor(s) (e.g., camera 104). In some non-limiting embodiments or aspects, autonomous vehicle 102 may use data from the sensor(s) (e.g., image data from camera 104) to facilitate at least one autonomous driving operation of the autonomous vehicle 102, as described herein. In some non-limiting embodiments or aspects, autonomous vehicle 102 may detect at least one object using the sensor(s) onboard the vehicle (e.g., using image data from camera 104 and/or the like).

Camera 104 may include at least one image capture device, such as a camera and/or the like, as described herein. In some non-limiting embodiments or aspects, camera 104 may include one or more devices capable of receiving information from and/or communicating information to autonomous vehicle 102 (e.g., computing device 108 thereof) and/or encoder device 106 (e.g., via any suitable communication connection and/or technique, such as peripheral component interconnect express (PCIe), peripheral component interconnect (PCI), Peripheral Component Interconnect eXtended (PCI-X), accelerated graphics port (AGP), Ethernet, system bus, universal serial bus (USB), gigabit multimedia serial link (GMSL), Mobile Industry Processor Interface (MIPI), Camera Serial Interface (CSI), Flat Panel Display Link (FPD-Link), and/or the like). Additionally or alternatively, each camera 104 may include a device capable of receiving information from and/or communicating information to other sensors (e.g., via any other suitable communication connection and/or technique, as described herein). In some non-limiting embodiments or aspects, camera 104 may be part of autonomous vehicle 102.

Encoder device 106 may include one or more devices capable of receiving information from and/or communicating information to autonomous vehicle 102 (e.g., computing device 108 thereof), camera 104, and/or computing device 108 (e.g., via any other suitable communication connection and/or technique, as described herein). In some non-limiting embodiments or aspects, encoder device 106 may include at least one computing device, such as a processor and/or processing device (e.g., applicant-specific integrated circuit (ASIC), one or more hardware encoders, and/or the like) connected to input and/or output interfaces (e.g., PCIe connectors, Ethernet network adapters, USB connectors, and/or the like) and/or to memory and/or data storage devices. In some non-limiting embodiments or aspects, encoder device 106 may include a printed circuit board and/or integrated circuit including (e.g., completely, partially, and/or the like) the aforementioned computing device and/or components thereof. In some non-limiting embodiments or aspects, encoder device 106 may by in communication with camera 104 and/or computing device 108 via at least one switch (e.g., a PCIe switch, an Ethernet switch, a switch for any type of communication connection described herein, and/or the like). In some non-limiting embodiments or aspects, encoder device 106 may be part of autonomous vehicle 102 and/or part of computing device 108.

Computing device 108 may include one or more devices capable of receiving information from and/or communicating information to autonomous vehicle 102, camera 104, encoder device 106, and/or remote system 110 (e.g., directly, indirectly via communication network 190, and/or any other suitable communication technique). In some non-limiting embodiments or aspects, computing device 108 may include at least one computing device, such as a vehicle on-board computing device, a portable and/or handheld device (e.g., a computer, a laptop, a personal digital assistant (PDA), a smartphone, a tablet, and/or the like), a server, and/or other like devices. For example, computing device 108 may include a vehicle on-board computing device, as described herein. In some non-limiting embodiments or aspects, computing device 108 may be part of autonomous vehicle 102.

Remote system 110 may include one or more devices capable of receiving information from and/or communicating information to autonomous vehicle 102 (e.g., computing device 108 thereof) and/or computing device 108 (e.g., directly, indirectly via communication network 190, and/or any other suitable communication technique). In some non-limiting embodiments or aspects, remote system 110 may include at least one computing device, such as a server, a group of servers, a portable and/or handheld device (e.g., a computer, a laptop, a personal digital assistant (PDA), a smartphone, a tablet, and/or the like), and/or other like devices. In some non-limiting embodiments or aspects, remote system 110 may include at least one of a remote guidance system, a mapping system, a tracking system tracking the location of one or more autonomous vehicles, a logging system maintaining records for potential liability, and/or the like.

Communication network 190 may include one or more wired and/or wireless networks. For example, communication network 190 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wireless LAN (WLAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, camera 104 may capture image data associated with a plurality of images. Camera 104 may communicate the image data to encoder device 106 (e.g., directly, indirectly via computing device 108, and/or the like). Encoder device 106 may receive the image data, as described herein. In some non-limiting embodiments or aspects, encoder device 106 may encode the image data into a plurality of video streams (e.g., at least one first video stream, at least one second video stream, etc.) of different quality levels (e.g., the first video stream(s) may be associated with a first quality level, the second video stream(s) may be associated with a second quality level different than the first quality level, etc.), as described herein. For example, the different quality levels may include a higher quality level (higher resolution, higher bit rate, higher frame rate, lower compression ratio, higher quality color/chroma format, and/or the like) and a lower quality level (lower resolution, lower bit rate, lower frame rate, higher compression ratio, lower quality color/chroma format, and/or the like), as described herein. In some non-limiting embodiments or aspects, encoder device 106 may communicate at least one of the plurality of video streams to at least one data storage device, as described herein. For example, encoder device 106 may communicate the video stream(s) to computing device 108, which may store the video stream(s) and/or communicate the video stream(s) to another device and/or system (e.g., remote system 110) for storage.

In some non-limiting embodiments or aspects, camera 104 may include at least one near field camera and/or at least one far field camera, as described herein. In some non-limiting embodiments or aspects, autonomous vehicle 102 (e.g., computing device 108 thereof) may include at least one graphics processor and/or at least one image signal processor (ISP), as described herein. For example, at least one first ISP may receive first image data (e.g., raw image data) from each respective far field camera and communicate the first image data to the graphics processor(s). Additionally or alternatively, at least one second ISP may receive second image data (e.g., raw image data) from each respective near field camera and communicate the second image data to the graphics processor(s). In some non-limiting embodiments or aspects, the graphics processor(s) may preprocess the raw image data (e.g., at least one of the first image data, the second image data, or any combination thereof) to form the image data (e.g., uncompressed image data) and communicate the image data to encoder device 106, as described herein. For example, preprocessing may include reducing a resolution of the raw image data (e.g., first image data, second image data, and/or the like), modifying a color format of the raw image data, any combination thereof, and/or the like. For example, such preprocessing may result in the uncompressed image data (e.g., the resolution thereof, color format thereof, and/or the like) being suitable for encoding by encoder device 106.

In some non-limiting embodiments or aspects, camera 104 may include multiple cameras (e.g., a first camera, a second camera, etc.; at least one near field camera and at least one far field camera; and/or the like), as described herein. The image data from each camera (e.g., the raw image data, the uncompressed image data from the graphics processor(s), and/or the like) may be received by encoder device 106 sequentially (e.g., in time order and/or the like) and/or in parallel. Additionally or alternatively, and encoder device 106 may encode the image data from each camera sequentially (e.g., in the order that the images were received and/or the like) and/or in parallel (e.g., if multiple independent hardware encoders are included in encoder device 106, two or more images may be encoded into two or more video streams in parallel), as described herein. For example, encoder device 106 may receive and store first image data associated with a first image of a first plurality of images from a first camera, and encoder device 106 may receive and store second image data associated with a second image of a second plurality of images from a second camera after receiving the first image. Additionally or alternatively, encoder device 106 may encode the first image data associated with the first image before encoding the second image data associated with the second image.

In some non-limiting embodiments or aspects, encoder device 106 may include a plurality of hardware encoders (e.g., a first hardware encoder, a second hardware encoder, etc.), as described herein. For example, at least one processor (e.g., a multi-core processor and/or the like) of encoder device 106 may include the hardware encoders. In some non-limiting embodiments or aspects, computing device 108 may include at least one processor (e.g., a central processing unit (CPU) and/or the like), which may be separate from the processor(s) of encoder device 106, as described herein. Additionally, computing device 108 may include a data storage device. In some non-limiting embodiments or aspects, encoder device 106 communicating the video stream(s) may include encoder device 106 (e.g., the processor(s) thereof) communicating at least one of the video stream(s) to computing device 108 (e.g., the CPU thereof), and computing device 108 (e.g., the CPU thereof) may store the video stream(s) in a data storage device, as described herein. In some non-limiting embodiments or aspects, encoder device 106 and/or computing device 108 may store at least one video stream (e.g., a first video stream, which may be a higher quality video stream) in a first data storage device of autonomous vehicle 102 (e.g., the first data storage device may be part of and/or connected to computing device 108). Additionally or alternatively, encoder device 106 and/or computing device 108 may communicate at least one video stream (e.g., a second video stream, which may be a lower quality video stream) to remote system 110 (e.g., via communication network 190) during operation of the autonomous vehicle 102. For example, remote system 110 may store the (second) video stream(s) in a second data storage device of remote system 110.

The number and arrangement of systems, devices, sensors (e.g., cameras), and/or networks shown in FIG. 1 are provided as an example. There may be additional systems, devices, sensors, and/or networks; fewer systems, devices, sensors, and/or networks; different systems, devices, sensors, and/or networks; and/or differently arranged systems, devices, sensors, and/or networks than those shown in FIG. 1. Furthermore, two or more systems, devices, or sensors shown in FIG. 1 may be implemented within a single system, device, or sensor, or a single system, device, or sensor shown in FIG. 1 may be implemented as multiple, distributed systems, devices, or sensors. Additionally or alternatively, a set of systems (e.g., one or more systems), a set of devices (e.g., one or more devices), or a set of sensors (e.g., one or more sensors) of system 100 may perform one or more functions described as being performed by another set of systems, another set of devices, or another set of sensors of system 100.

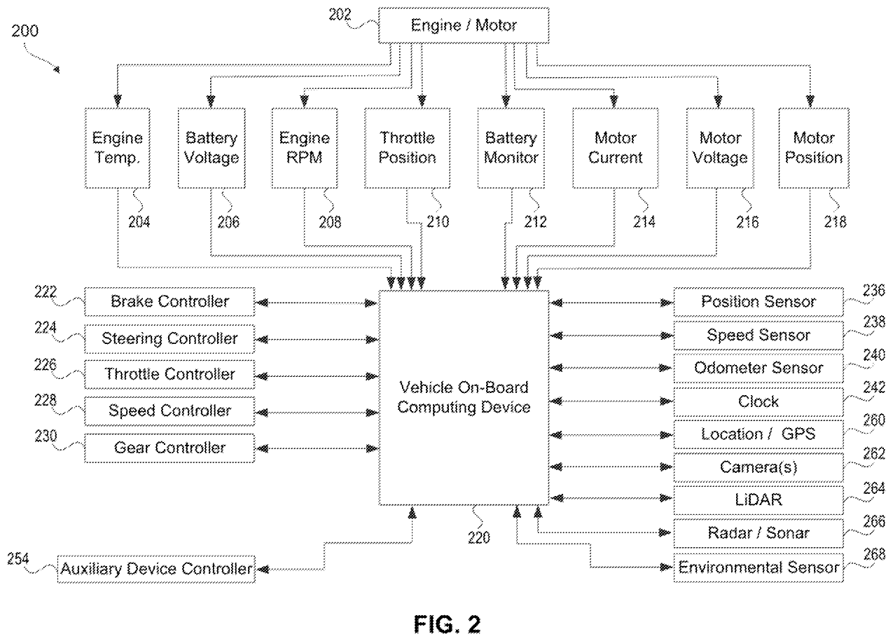

Referring now to FIG. 2, FIG. 2 is an illustration of an illustrative system architecture 200 for a vehicle, according to some non-limiting embodiments or aspects of the presently disclosed subject matter. In some non-limiting embodiments or aspects, autonomous vehicle 102 may include a same or similar system architecture as that of system architecture 200 shown in FIG. 2. In some non-limiting embodiments or aspects, computing device 108 may be the same as or similar to vehicle on-board computing device 220. In some non-limiting embodiments or aspects, encoder device 106 may be part of or connected to vehicle on-board computing device 220. In some non-limiting embodiments or aspects, camera 104 may be the same as or similar to camera 262.

The number and arrangement of components shown in FIG. 2 are provided as an example. In some non-limiting embodiments or aspects, system architecture 200 may include additional components, fewer components, different components, or differently arranged components than those shown in FIG. 2. Additionally, or alternatively, a set of components (e.g., one or more components) of system architecture 200 may perform one or more functions described as being performed by another set of components of system architecture 200.

As shown in FIG. 2, system architecture 200 may include engine or motor 202 and various sensors 204-218 for measuring various parameters of the vehicle. In gas-powered or hybrid vehicles having a fuel-powered engine 202, the sensors may include, for example, engine temperature sensor 204, battery voltage sensor 206, engine rotations per minute (RPM) sensor 208, and/or throttle position sensor 210. In an electric or hybrid vehicle, the vehicle may have an electric motor 202, and may have sensors such as battery monitoring sensor 212 (e.g., to measure current, voltage, and/or temperature of the battery), motor current sensor 214, motor voltage sensor 216, and/or motor position sensors 218, such as resolvers and encoders.

System architecture 200 may include operational parameter sensors, which may be common to both types of vehicles, and may include, for example: position sensor 236 such as an accelerometer, gyroscope, and/or inertial measurement unit; speed sensor 238; and/or odometer sensor 240. System architecture 200 may include clock 242 that the system architecture 200 uses to determine vehicle time during operation. Clock 242 may be encoded into the vehicle on-board computing device 220, it may be a separate device, or multiple clocks may be available.

System architecture 200 may include various sensors that operate to gather information about an environment in which the vehicle is operating and/or traveling. These sensors may include, for example: location sensor 260 (e.g., a Global Positioning System (GPS) device); object detection sensors such as one or more cameras 262; LiDAR sensor system 264; and/or radar and/or sonar system 266. The sensors may include environmental sensors 268, such as a precipitation sensor and/or ambient temperature sensor. The object detection sensors may enable the system architecture 200 to detect objects that are within a given distance range of the vehicle in any direction, and the environmental sensors 268 may collect data about environmental conditions within an area of operation and/or travel of the vehicle.

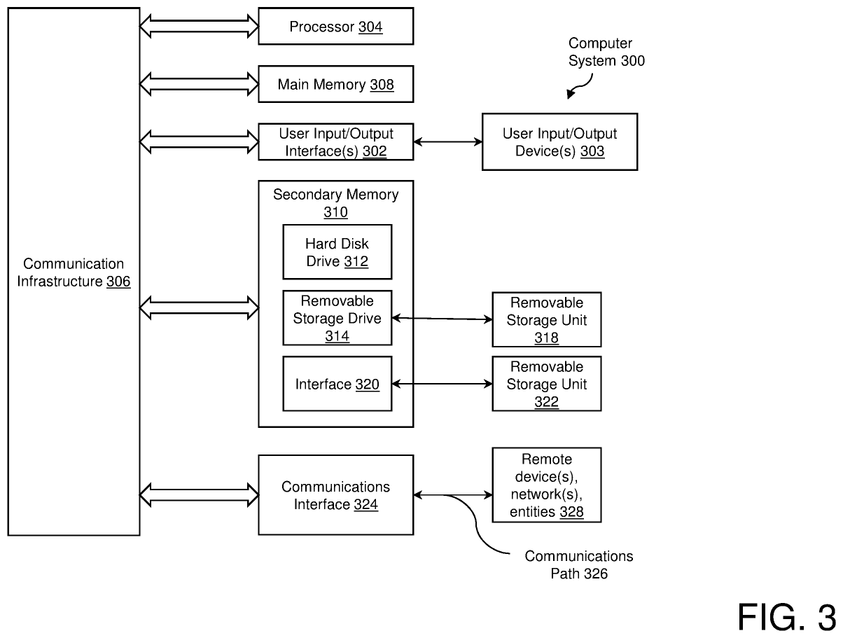

During operation of system architecture 200, information is communicated from the sensors of system architecture 200 to on-board computing device 220. The on-board computing device 220 may be implemented using the computer system of FIG. 3. Vehicle on-board computing device 220 analyzes the data captured by the sensors and optionally controls operations of the vehicle based on results of the analysis. For example, vehicle on-board computing device 220 may control: braking via a brake controller 222; direction via steering controller 224; speed and acceleration via throttle controller 226 (e.g., in a gas-powered vehicle) or motor speed controller 228 such as a current level controller (e.g., in an electric vehicle); differential gear controller 230 (e.g., in vehicles with transmissions); and/or other controllers such as auxiliary device controller 254.

Geographic location information may be communicated from location sensor 260 to vehicle on-board computing device 220, which may access a map of the environment including map data that corresponds to the location information to determine known fixed features of the environment, such as streets, buildings, stop signs, and/or stop/go signals. Captured images from cameras 262 and/or object detection information captured from sensors, such as LiDAR sensor system 264 and/or radar and/or sonar system 266, is communicated from those sensors to vehicle on-board computing device 220. The object detection information and/or captured images are processed by on-board computing device 220 to detect objects in proximity to the vehicle. Any known or to be known techniques for making an object detection based on sensor data and/or captured images can be used in the embodiments or aspects disclosed in this document. Vehicle on-board computing device 220 may generate new map data (e.g., based on object detection data captured from sensors such as LiDAR 264, captured images from cameras 262, the map data, and/or the like). Additionally or alternatively, vehicle on-board computing device 220 may communicate sensor data (e.g., object detection data captured from sensors such as LiDAR 264, captured images from cameras 262, and/or the like) to a remote system (e.g., remote system 119), which may generate new map data based on the sensor data.

Various embodiments can be implemented, for example, using one or more computer systems, such as computer system 300 shown in FIG. 3. Computer system 300 can correspond to one or more devices of (e.g., one or more devices of a system of) autonomous vehicle 102, camera 104, encoder device 106, computing device 108, and/or remote system 110. In some non-limiting embodiments or aspects, one or more devices of (e.g., one or more devices of a system of) autonomous vehicle 102, camera 104, encoder device 106, computing device 108, and/or remote system 110 may include at least one computing device 300 and/or at least one component of computer system 300. Computer system 300 can be any computer capable of performing the functions described herein.

In some non-limiting embodiments or aspects, computer system 300 may be any computer capable of performing the functions described herein.

Computer system 300 may include one or more processors (also called central processing units, or CPUs), such as a processor 304. Processor 304 is connected to a communication infrastructure or bus 306.

One or more processors 304 may each be a graphics processing unit (GPU). In some non-limiting embodiments or aspects, a GPU may include a processor that is a specialized electronic circuit designed to process mathematically intensive applications. The GPU may have a parallel structure that is efficient for parallel processing of large blocks of data, such as mathematically intensive data common to computer graphics applications, images, videos, etc. In some non-limiting embodiments or aspects, one or more processors 304 (e.g., CPU, GPU, and/or the like) may include, be part of, and/or be connected to one or more hardware accelerators. For example, a hardware accelerator may include an artificial intelligence (AI) accelerator.

Computer system 300 also may include user input/output device(s) 303, such as monitors, keyboards, pointing devices, etc., that communicate with communication infrastructure 306 through user input/output interface(s) 302.

Computer system 300 also may include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, removable solid state drive (SSD), removable hard disk drive, and/or any other computer data storage device. Removable storage drive 314 reads from and/or writes to removable storage unit 318 in any suitable manner.

In some non-limiting embodiments or aspects, secondary memory 310 may include other means, instrumentalities, or other approaches for allowing computer programs and/or other instructions and/or data to be accessed by computer system 300. Such means, instrumentalities, or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of remote devices, remote networks, remote entities, etc. (individually and collectively referenced by reference number 328). For example, communication interface 324 may allow computer system 300 to communicate with remote devices 328 over communications path 326, which may be wired and/or wireless, and which may include any combination of LANs, WANs, the Internet, etc. Control logic and/or data may be transmitted to and from computer system 300 via communication path 326.

In some non-limiting embodiments or aspects, a tangible, non-transitory apparatus or article of manufacture comprising a tangible, non-transitory computer useable or readable medium having control logic (software) stored thereon also may be referred to herein as a computer program product or program storage device. This may include, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

The number and arrangement of components shown in FIG. 3 are provided as an example. In some non-limiting embodiments or aspects, computer system 300 may include additional components, fewer components, different components, or differently arranged components than those shown in FIG. 3. Additionally, or alternatively, a set of components (e.g., one or more components) of computer system 300 may perform one or more functions described as being performed by another set of components of computer system 300.

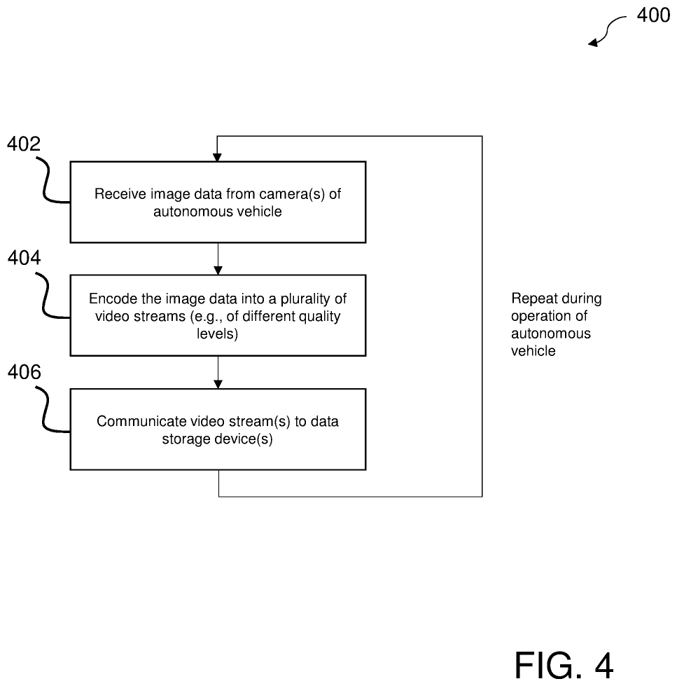

Referring now to FIG. 4, FIG. 4 is a flowchart of a non-limiting embodiment or aspect of a process 400 for video encoding for autonomous vehicles, according to some non-limiting embodiments or aspects of the presently disclosed subject matter. In some non-limiting embodiments or aspects, one or more of the steps of process 400 may be performed (e.g., completely, partially, and/or the like) by encoder device 106. In some non-limiting embodiments or aspects, one or more of the steps of process 400 may be performed (e.g., completely, partially, and/or the like) by another system, another device, another group of systems, or another group of devices, separate from or including encoder device 106, such as autonomous vehicle 102, camera 104, computing device 108, remote system 110, and/or the like. The number and arrangement of steps shown in FIG. 4 are provided as an example. In some non-limiting embodiments or aspects, process 400 may include additional steps, fewer steps, different steps, or differently arranged steps than those shown in FIG. 4.

As shown in FIG. 4, at step 402, process 400 may include receiving image data from at least one camera of an autonomous vehicle. For example, encoder device 106 may receive image data associated with a plurality of images from at least one camera 104 of autonomous vehicle 102.

In some non-limiting embodiments or aspects, autonomous vehicle 102 may include a plurality of cameras 104, as described herein. In some non-limiting embodiments or aspects, autonomous vehicle 102 may include at least one ISP and/or a least one graphics processor, as described herein. For example, the ISP(s) may receive raw image data from the camera(s). Additionally or alternatively, the graphics processor(s) may receive the raw image data from the camera(s) and/or from the ISP(s) and may preprocess the raw image data to form the image data (e.g., uncompressed image data) for communicating to encoder device 106.

In some non-limiting embodiments or aspects, the cameras 104 of autonomous vehicle 102 may include at least one near field camera and/or at least one far field camera. In some non-limiting embodiments or aspects, at least one ISP (e.g., one or more first ISPs) may receive first image data (e.g., raw image data) from each respective far field camera. Additionally or alternatively, at least one ISP (e.g., one or more second ISPs) may receive second image data (e.g., raw image data) from each respective near field camera. The ISP(s) (e.g., the first ISP(s) and/or the second ISP(s)) may communicate the raw image data (e.g., the first image data and/or the second image data) from each respective camera (e.g., the far field camera(s) and/or the near field camera(s)) to the graphics processor(s) and/or to encoder device 106. In some non-limiting embodiments or aspects, the graphics processor(s) may preprocess the raw image data (e.g., the first image data, the second image data, and/or any combination thereof) to form the image data (e.g., uncompressed image data) for communicating to encoder device 106. In some non-limiting embodiments or aspects, preprocessing may include modifying the raw image data to form image data suitable for encoding by encoder device 106. For example, preprocessing may include at least one of reducing a resolution of the raw image data, modifying a color format of the raw image data, and/or any combination thereof. In some non-limiting embodiments or aspects, preprocessing may include generating two or more streams of image data (e.g., uncompressed image data) from one raw image data stream. For example, one stream of image data may with a certain resolution (e.g., lower resolution) may be generated for lower quality level encoding, and/or another stream of image data with a certain resolution (e.g., higher resolution) may be generated for higher quality encoding. In some non-limiting embodiments or aspects, the graphics processor(s) may communicate the image data (e.g., one or more streams of image data) to encoder device 106.

In some non-limiting embodiments or aspects, camera 104 may include multiple cameras (e.g., a first camera, a second camera, etc.; at least one near field camera and at least one far field camera; and/or the like), as described herein. The image data from each camera (e.g., the raw image data, the uncompressed image data from the graphics processor(s), and/or the like) may be received by encoder device 106 sequentially (e.g., in time order and/or the like) and/or in parallel. For example, encoder device 106 may receive and store first image data associated with a first image of a first plurality of images from a first camera, and encoder device 106 may receive and store second image data associated with a second image of a second plurality of images from a second camera after receiving the first image.

As shown in FIG. 4, at step 404, process 400 may include encoding the image data into a plurality of video streams (e.g., of different quality levels). For example, encoder device 106 may encode the image data into a plurality of video streams. In some non-limiting embodiments or aspects, the video stream(s) may be associated with different quality levels. For example, at least one first video stream may be associated with a first quality level (e.g., a higher quality level). Additionally or alternatively, at least one second video stream may be associated with a second quality level (e.g., a lower quality level) different than the first quality level.

In some non-limiting embodiments or aspects, encoder device 106 may encode each video stream according to a video encoding standard, such as HEVC (e.g., Recommendation ITU-T H.265, High Efficiency Video Coding, International Telecommunication Union (August 2021)), AVC (e.g., Recommendation ITU-T H.264, Advanced Video Coding for Generic Audiovisual Services, International Telecommunication Union (August 2021)), MPEG-2 (Recommendation ITU-T H.262, Information Technology—Generic Coding of Moving Pictures and Associated Audio Information: Video: Frame Packing Arrangement Signalling for 3D Content, International Telecommunication Union (February 2012)), MPEG-4 (ISO/IEC 14496-10:2020(E), Information Technology—Coding of Audio-Visual Objects—Part 10: Advanced Video Coding, International Organization for Standardization (ISO) and the International Electrotechnical Commission (IEC) (December 2020)), successor versions of any of the aforementioned standards, any combination thereof, and/or the like, and the disclosures of the aforementioned standards are incorporated by reference herein in their entireties. For example, encoder device 106 may include at least one encoder configured to encode image data according to such a video encoding standard. In some non-limiting embodiments or aspects, encoder device 106 may include at least one HEVC encoder (e.g., a plurality of HEVC hardware encoders). In some non-limiting embodiments or aspects, encoder device 106 may encode the image data into a plurality of video streams using the HEVC encoder(s).

In some non-limiting embodiments or aspects, the different quality levels may include a higher quality level (higher resolution, higher bit rate, higher frame rate, lower compression ratio, higher quality color/chroma format, and/or the like) and a lower quality level (lower resolution, lower bit rate, lower frame rate, higher compression ratio, lower quality color/chroma format, and/or the like), as described herein. In some non-limiting embodiments or aspects, the higher quality level video stream may include a higher profile, higher tier, and/or higher level, as described in HEVC, and the lower quality level video stream may include a lower profile, lower tier, and/or lower level, as described in HEVC. In some non-limiting embodiments or aspects, the higher quality level video stream may include a higher spatial level/layer, a higher temporal level/layer, and/or higher signal-to-noise (SNR) level/layer (sometimes referred to in AVC as quality level/layer), as described in AVC, and the lower quality level video stream may include a lower spatial level/layer, a lower temporal level/layer, and/or lower SNR level/layer, as described in AVC.

In some non-limiting embodiments or aspects, encoder device 106 may encode the image data into the plurality of video streams in real time and/or during operation of the autonomous vehicle 102. Additionally or alternatively, encoder device 106 may encode the image data into the plurality of video streams substantially simultaneously (e.g., using two or more hardware encoders in parallel).

In some non-limiting embodiments or aspects, encoder device 106 (e.g., a processor thereof) may include a plurality of hardware encoders (e.g., a first hardware encoder and a second hardware encoder). For example, encoding the image data may include encoding the image data into the at least one first video stream with the first hardware encoder and encoding the image data into the at least one second video stream with the second hardware encoder. Additionally or alternatively, the first hardware encoder may encode the image data into the first video stream independent of the second hardware encoder encoding the image data into the at least one second video stream.

In some non-limiting embodiments or aspects, each hardware encoder may include a software-configurable hardware encoder. For example, the first hardware encoder may include a first software-configurable hardware encoder and the second hardware encoder may include a second software-configurable hardware encoder. In some non-limiting embodiments or aspects, the first software-configurable hardware encoder may encode the image data into one of the at least one first video stream or the at least one second video stream based on a first software configuration of the first software-configurable hardware encoder. Additionally or alternatively, the second software-configurable hardware encoder may encode the image data into one of the at least one first video stream or the at least one second video stream based on a second software configuration of the second software-configurable hardware encoder.

In some non-limiting embodiments or aspects, encoder device 106 may encode a plurality of video streams for the image data from each camera 104. For example, if autonomous vehicle 102 includes multiple cameras, encoder device 106 may encode a plurality of video streams (e.g., a higher quality video stream and a lower quality video stream) for each camera 104 (e.g., based on the image data from each respective camera 104).

In some non-limiting embodiments or aspects, camera 104 may include multiple cameras (e.g., a first camera, a second camera, etc.; at least one near field camera and at least one far field camera; and/or the like), as described herein. The image data from each camera (e.g., the raw image data, the uncompressed image data from the graphics processor(s), and/or the like) may be received by encoder device 106 sequentially (e.g., in time order and/or the like) and/or in parallel. Additionally or alternatively, and encoder device 106 may encode the image data from each camera sequentially (e.g., in the order that the images were received and/or the like) and/or in parallel (e.g., if multiple independent hardware encoders are included in encoder device 106, two or more images may be encoded into two or more video streams in parallel), as described herein. For example, encoder device 106 may receive and store first image data associated with a first image of a first plurality of images from a first camera, and encoder device 106 may receive and store second image data associated with a second image of a second plurality of images from a second camera after receiving the first image. Additionally or alternatively, encoder device 106 may encode the first image data associated with the first image before encoding the second image data associated with the second image.

As shown in FIG. 4, at step 406, process 400 may include communicating at least one of the video streams to at least one data storage device. For example, encoder device 106 may communicate at least one of the plurality of video streams to at least one data storage device. In some non-limiting embodiments or aspects, encoder device 106 may communicate the video stream(s) to computing device 108, which may store at least one of the video stream(s) (e.g., in a data storage device of computing device 108) and/or may communicate at least one of the video stream(s) to another device and/or system (e.g., remote system 110) for storage (e.g., in a data storage device of remote system 110).

In some non-limiting embodiments or aspects, encoder device 106 may communicate at least one of the video stream(s) to a CPU (e.g., of computing device 108). Additionally or alternatively, the CPU (e.g., of computing device 108) may store the at least one of the video stream(s) in at least one data storage device (e.g., of computing device 108, connected to computing device 108, remote from computing device 108, and/or the like).

In some non-limiting embodiments or aspects, encoder device 106 and/or computing device 108 may store at least one first video stream (e.g., higher quality video stream(s)) in a first data storage device of autonomous vehicle 102 (e.g., a first data storage device that is part of or connected to computing device 108), for example, during operation of autonomous vehicle 102. Additionally or alternatively, encoder device 106 and/or computing device 108 may communicate at least one second video stream (e.g., lower quality video stream(s)) to remote system 110 (e.g., via communication network 190, such as a cellular network and/or the like), for example, during operation of autonomous vehicle 102. Remote system 110 may store the second video stream(s) in a second data storage device of remote system 110. In some non-limiting embodiments or aspects, encoder device 106 and/or computing device 108 may communicate the first video stream(s) from the first data storage device to remote system 110 after ceasing operation of the autonomous vehicle 102 (e.g., via direct connection; via communication network 190, such as a Wi-Fi network; and/or the like, which may have greater speed and/or throughput availability than the cellular network available during operation of autonomous vehicle 102).

In some non-limiting embodiments or aspects, autonomous vehicle 102 and/or computing device 108 may facilitate at least one autonomous driving operation of autonomous vehicle 102 based on at least one of the plurality of video streams. For example, the video stream(s) may be used as input to a vehicle on-board computing device (e.g., computing device 108, vehicle on-board computing device 220, and/or the like), which may analyze the video stream and optionally control operations of autonomous vehicle 102 based on results of the analysis.

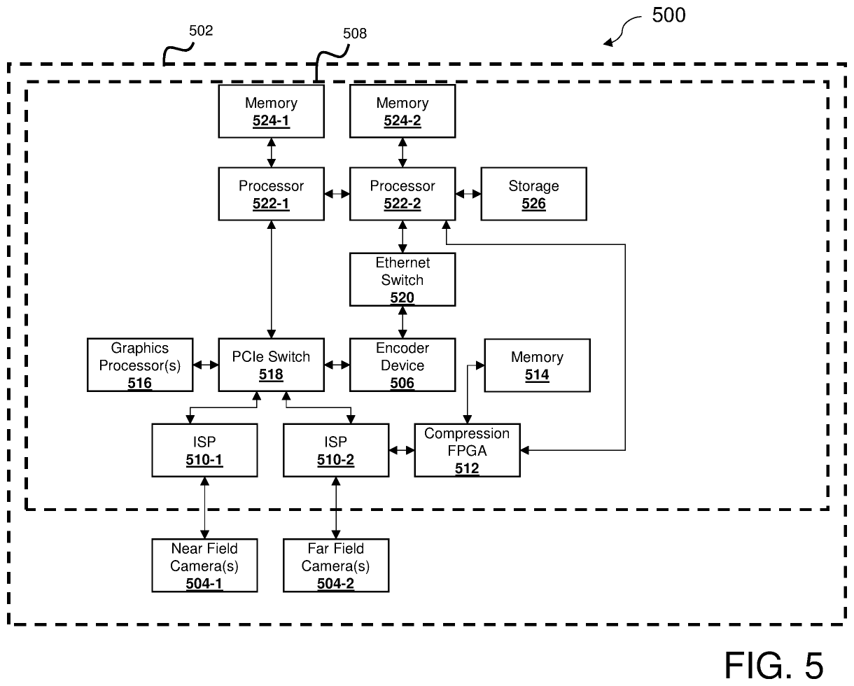

Referring now to FIG. 5, FIG. 5 is a diagram of an exemplary implementation 500 of a system for video encoding for autonomous vehicles, according to some non-limiting embodiments or aspects of the presently disclosed subject matter. As shown in FIG. 5, implementation 500 may include autonomous vehicle 502, near field camera(s) 504-1 and far field cameras 504-2 (collectively “cameras 504” and individually “camera 504”), encoder device 506, computing device 508, first ISP 510-1 and second ISP 510-2 (collectively “ISPs 510” and individually “ISP 510”), compression field programmable gate array (FPGA) 512, memory 514, graphics processor 516, PCIe switch 518, ethernet switch 520, first processor 522-1 and second processor 522-2 (collectively “processors 522” and individually “processor 522”), first memory 524-1 and second memory 524-2 (collectively “memories 524” and individually “memory 524”), and/or storage 526. In some non-limiting embodiments or aspects, autonomous vehicle 502 may be the same as or similar to autonomous vehicle 102. In some non-limiting embodiments or aspects, cameras 504 may be the same as or similar to camera 104. In some non-limiting embodiments or aspects, encoder device 506 may be the same as or similar to encoder device 106. In some non-limiting embodiments or aspects, computing device 508 may be the same as or similar to computing device 108. The number and arrangement of components shown in FIG. 5 are provided as an example. In some non-limiting embodiments or aspects, implementation 500 may include additional components, fewer components, different components, or differently arranged components than those shown in FIG. 5. Additionally or alternatively, a set of components (e.g., one or more components) of implementation 500 may perform one or more functions described as being performed by another set of components of implementation 500.

In some non-limiting embodiments or aspects, cameras 504 may capture images (e.g., raw image data), as described herein. For example, near field camera(s) 504-1 may capture images of the environment near autonomous vehicle 502. Additionally or alternatively, far field camera(s) 504-2 may capture images of the environment further from autonomous vehicle 502. In some non-limiting embodiments or aspects, cameras 504 may communicate the images to ISPs 510. For example, cameras 504 may be connected to and/or communicate with ISPs 510 via MIPI connection, such as a CSI connection and/or the like.

In some non-limiting embodiments or aspects, ISPs 510 may receive the images (e.g., raw image data) from cameras 504, as described herein. For example, ISPs 510 may include FPGAs to receive the images from cameras 504 via the MIPI connection. Additionally or alternatively, ISPs 510 may communicate the images (e.g., raw image data) to PCIe switch 518 and/or compression FPGA 512. For example, ISPs 510 may be connected to and/or communicate with PCIe switch 518 via a high speed bus connection, such as a PCIe connection and/or the like. For example, first ISP 510-1 may be connected to PCIe switch 518 via a third generation, four-lane PCIe connection (e.g., PCIe 3×4), and second ISP 510-2 may be connected to PCIe switch 518 via a third generation, eight lane PCIe connection (e.g., PCIe 3×8). Additionally or alternatively, ISPs 510 may be connected to and/or communicate with compression FPGA 512 via a high speed serial link, such as an Aurora connection and/or the like.

In some non-limiting embodiments or aspects, compression FPGA 512 may compress the images (e.g., raw image data from cameras 504, preprocessed/uncompressed image data from graphics processors 516, and/or the like), for example, into a format suitable for processors 522 (e.g., second processor 522-2) and/or any other suitable format. Additionally or alternatively, FPGA 512 may not compress at least some (e.g., all) of the images (e.g., simply receiving and forwarding the images). In some non-limiting embodiments or aspects, compression FPGA 512 may communicate and/or store the compressed images in memory 514, which may include a RAM and/or volatile memory, such as double data rate synchronous dynamic random-access memory (DDR SDRAM). In some non-limiting embodiments or aspects, FPGA 512 may be connected to and/or communicate with memory 514 via at least one high speed bus connection, such as at least one memory bus connection. In some non-limiting embodiments or aspects, FPGA 512 may communicate, provide, and/or otherwise make available the compressed and/or preprocessed images to second processor 522-2. For example, FPGA 512 may be connected to and/or communicate with second processor 522-2 via a high speed bus connection, such as a third generation, 16-lane PCIe connection (e.g., PCIe 3×16) and/or the like.

In some non-limiting embodiments or aspects, PCIe switch 518 may communicate (e.g., route) the images (e.g., raw image data) to graphics processor(s) 516, may receive the images, as described herein. For example, PCIe switch 518 may be connected to and/or communicate with graphic processor(s) via a high speed bus connection, such as a third generation, 16-lane PCIe connection (e.g., PCIe 3×16) and/or the like. In some non-limiting embodiments or aspects, graphics processor(s) 516 may include at least one graphics processing unit (GPU), at least one graphics transmission subsystem (e.g., a DisplayPort transmission subsystem), and/or the like. For example, graphics processor(s) 516 may include a plurality of GPUS, graphics transmission subsystems, and/or the like. In some non-limiting embodiments or aspects, graphics processor(s) 516 may preprocess the images (e.g., raw image data) to form image data (e.g., uncompressed image data) suitable for encoder device 506, as described herein. In some non-limiting embodiments or aspects, graphics processor(s) 516 may communicate the image data to PCIe switch 518, which may communicate the image data (e.g., uncompressed image data) to at least one of second ISP 510-2 and/or encoder device 506. For example, PCIe switch 518 may be connected to and/or communicate with encoder device 506 via a high speed bus connection, such as a third generation, 4-lane PCIe connection (e.g., PCIe 3×₄), a third generation, 8-lane PCIe connection (e.g., PCIe 3×8), and/or the like. In some non-limiting embodiments or aspects, the connection between PCIe switch 518 and encoder device 506 may include a connection with a throughput that does not exceed the throughput capacity of encoder device 506, that matches the throughput capacity of encoder device 506, that is the smallest number of lanes to exceed (e.g., slightly exceed) the throughput capacity of encoder device 506, and/or the like. For example, if the throughput capacity of encoder device 506 is about 3.2 GB/s, the connection between PCIe switch 518 and encoder device 506 may include a third generation, 4-lane PCIe connection (e.g., PCIe 3×4) with a throughput of about 3.8-3.94 GB/s.

In some non-limiting embodiments or aspects, encoder device 506 may receive the image data from PCIe switch 518 (e.g., from cameras 504 via ISPs 510, graphics processor(s) 516, and PCIe switch 518, and/or the like). In some non-limiting embodiments or aspects, encoder device 506 may encode the image data into a plurality of video streams of different quality levels, as described herein.

In some non-limiting embodiments or aspects, encoder device 506 may communicate at least one of the video streams to processor(s) 522. For example, encoder device 506 may communicate at least one of the video streams via PCIe switch 518 to processors 522. For example, PCIe switch 518 may be connected to and/or communicate with first processor 522-1 via a high speed bus connection, such as a third generation, 16-lane PCIe connection (e.g., PCIe 3×16) and/or the like. Additionally or alternatively, encoder device 506 may communicate at least one of the video streams via Ethernet switch 520 to second processor 522-2. For example, encoder device 506 may be connected to and/or communicate with Ethernet switch 520 via an Ethernet connection (e.g., a 10G Ethernet connection and/or the like), and Ethernet switch may be connected to second processor 522-2 via an Ethernet connection (e.g., a 10G Ethernet connection and/or the like).

In some non-limiting embodiments or aspects, PCIe switch 518 may be connected encoder device 506 by a non-transparent bridge (NTB) (e.g., to the PCIe tree). Additionally or alternatively, encoder device 506 may be connected by an Ethernet connection to Ethernet switch 520. In some non-limiting embodiments or aspects, first processor 522-1 may be connected to and/or communicate with second processor 522-2 via a high speed bus connection, such as a third generation, 16-lane PCIe connection (e.g., PCIe 3×16); an NTB; an Ethernet connection; any combination thereof; and/or the like.

In some non-limiting embodiments or aspects, at least one of processors 522 may store the video stream(s) in at least one of memories 524. In some non-limiting embodiments or aspects, respective processors 522 may be connected to and/or communicate with respective memories 524 via at least one high speed bus connection, such as at least one memory bus connection. For example, second processor 522-2 may store the video streams (at least temporarily) in second memory 524-2. For example, second memory 524-2 may act as a frame buffer for frames of the video stream(s) received by second processor 522-2. In some non-limiting embodiments or aspects, processors 522 (e.g., second processor 522-2) may store the video stream(s) in storage 526 and/or communicate the video stream(s), as described herein. In some non-limiting embodiments or aspects, at least one of processors 522 (e.g., second processor 522-2) may be a CPU of computing device 508 (e.g., a vehicle on-board computing device of autonomous vehicle 502). In some non-limiting embodiments or aspects, memories 524 each may include a RAM and/or volatile memory, such as double data rate synchronous dynamic random-access memory (DDR SDRAM). In some non-limiting embodiments or aspects, storage 526 may include a non-volatile memory, such as a SSD, a Non-Volatile Memory Express (NVMe) SSD, and/or the like. For example, second processor 522-2 may be connected to and/or communicate with storage 526 via at least one high speed bus connection, such as two third generation, four-lane PCIe connections (e.g., PCIe 3×4).

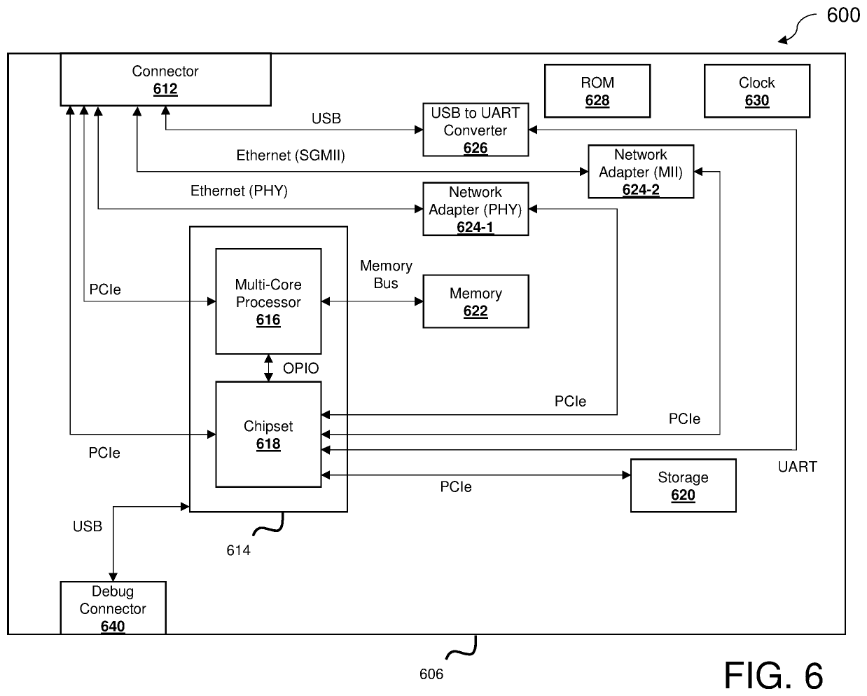

Referring now to FIG. 6, FIG. 6 is a diagram of an exemplary implementation 600 of a device for video encoding for autonomous vehicles, according to some non-limiting embodiments or aspects of the presently disclosed subject matter. As shown in FIG. 6, implementation 600 may include encoder device 606, connector 612, processor package 614, multi-core processor 616, chipset 618, storage 620, memory 622, first network adapter 624-1 and second network adapter 624-2 (collectively “network adapters 624” and individually “network adapter 624”), USB to universal asynchronous receiver-transmitter (UART) converter 626, read only memory (ROM) 628, clock 630, and/or debug connector 640. In some non-limiting embodiments or aspects, encoder device 606 may be the same as or similar to encoder device 106 and/or encoder device 506. The number and arrangement of components shown in FIG. 6 are provided as an example. In some non-limiting embodiments or aspects, implementation 600 may include additional components, fewer components, different components, or differently arranged components than those shown in FIG. 6. Additionally or alternatively, a set of components (e.g., one or more components) of implementation 600 may perform one or more functions described as being performed by another set of components of implementation 600.

In some non-limiting embodiments or aspects, encoder device 606 may include a printed circuit board. Additionally or alternatively, at least one (e.g., all) of the components of encoder device 606 (e.g., connector 612, processor package 614, multi-core processor 616, chipset 618, storage 620, memory 622, network adapters 624, USB to UART converter 626, and/or debug connector 640) may be included on the printed circuit board.

In some non-limiting embodiments or aspects, connector 612 may include at least one connector for connecting encoder device 606 to other components of an autonomous vehicle (e.g., autonomous vehicle 102) and/or a computing device (e.g., computing device 108) thereof. For example, connector 612 may include at least one high speed bus connector, such as at least one PCIe connector (e.g., two third generation, four-lane PCIe connections (e.g., PCIe 3×4)). Additionally or alternatively, connector 612 may include at least one Ethernet connector (a physical layer (PHY) connector, a media-independent interface (MII) connector, and/or the like). Additionally or alternatively, connector 612 may include at least one USB connector.

In some non-limiting embodiments or aspects, encoder device 606 (e.g., connector 612 thereof) may include at least two types of connections. For example, a first type of connection may be for (e.g., suitable for, designed for, and/or the like) on-chip, chip-to-chip, chip-to-board, or board-to-board communication, such as PCIe and/or the like, as described herein. Additionally or alternatively, a second type of connection may be suitable for device-to-device, device-to-system, and/or system-to-system communication, such as Ethernet and/or the like. For example, encoder device 606 may receive image data over a first communication channel (e.g., via the first type of connection, such as PCIe), and/or encoder device 606 may communicate one or more video streams (e.g., after encoding the image data into the video streams) over a second communication channel (e.g., via a second connection type, such as Ethernet). For example, encoder device 606 (e.g., the printed circuit board of encoder device 606 including the components of encoder device 606) may be part of and/or connected to a board (e.g., via PCIe slot and/or the like) including a first processor (e.g., first processor 522-1 of computing device 508, a first processor of computing device 108, and/or the like) using the first type of connection, and encoder device 606 may communicate the video stream(s) to a second processor (e.g., second processor 522-2 (e.g., CPU) of computing device 508, a second processor (e.g., CPU) of computing device 108, and/or the like) using the second type of connection (e.g., because the second processor may be on a separate board than the first processor). For example, the first processor may coordinate the communication of the images and/or image data from the cameras over the first type of connection (e.g., PCIe connection to the ISPs, graphics processors, and/or PCIe switch) to encoder device 606. Additionally or alternatively, the second processor may receive the video stream(s) from encoder device 606 over the second type of connection (e.g., Ethernet connection to the Ethernet switch and/or second processor) and store (e.g., in storage 526, computing device 108, and/or the like) and/or communicate (e.g., to remote system 110 and/or the like), as described herein.

In some non-limiting embodiments or aspects, processor package 614 may include multi-core processor 616 and chipset 618. For example, multi-core processor 616 may be dedicated to receiving image data from the camera(s) of the autonomous vehicle and encoding the image data into the multiple video streams of different quality levels, as described herein. Additionally or alternatively, chipset 618 may communicate with the other components of encoder device 606 and/or other components of the autonomous vehicle. In some non-limiting embodiments or aspects, chipset 618 may include a peripheral controller hub, a platform controller hub, and/or the like. In some non-limiting embodiments or aspects, connector 612 may have at least one high speed bus connection (e.g., a first third generation, four-lane PCIe connection (e.g., PCIe 3×4)) connected to multi-core processor 616, and this connection may be dedicated to communicating the image data directly to multi-core processor 616. Additionally or alternatively, connector 612 may have at least one other high speed bus connection (e.g., a second third generation, four-lane PCIe connection (e.g., PCIe 3×4)) connected to chipset 618, which may be used to communicate other data (e.g., command and/or control data from the processor(s) of the computing device of the autonomous vehicle, metadata related to the image data, and/or the like). In some non-limiting embodiments or aspects, multi-core processor 616 may be connected to and/or communicate with chipset 618 via an on-package input/output (OPIO) connection.

In some non-limiting embodiments or aspects, processor package 614 (e.g., including multi-core processor 616 and chipset 618) may include a mobile processor, an embedded processor, and/or an embedded mobile processor. For example, processor package 614 may include an embedded mobile processor, which may have sufficient throughput capacity to encode the image data into the multiple video streams of different quality levels, as described herein, while also meeting other tolerance demands of an autonomous vehicle, such as low power consumption, noise tolerance, heat tolerance, connectivity to multiple input/output interfaces (e.g., of different types of communication connections), software-based configurability, and/or the like. For the purpose of illustration, processor package 614 may include an embedded mobile processor.

In some non-limiting embodiments or aspects, multi-core processor 616 may store (e.g., temporarily store) the image data and/or the video stream(s) in memory 622, as described herein. For example, memory 622 may include at least one RAM and/or volatile memory, such as at least one (e.g., two, four, and/or the like) low power DDR SDRAM (LPDDR). In some non-limiting embodiments or aspects, multi-core processor 616 may be connected to and/or communicate with memory 622 via at least one high speed bus connection, such as at least one memory bus connection (e.g., four memory bus connections with 32-bit width (4×32). For example, the number and bit width of memory bus connections between multi-core processor 616 and memory 622 may the same as the number of memories of memory 622 (e.g., a memory bus connection for each of four LPDDR memories). In some non-limiting embodiments or aspects, the memory 622 (e.g., LPDDR memory and/or the like) may have sufficient memory capacity and/or throughput capacity to store the image data and/or video streams, while also meeting other tolerance demands of an autonomous vehicle, such as low power consumption, noise tolerance, heat tolerance, and/or the like.

In some non-limiting embodiments or aspects, multi-core processor 616 may include at least one hardware encoder, as described herein. For example, multi-core processor 616 may include two hardware encoders, which may operate independent of (e.g., in parallel with) each other. In some non-limiting embodiments or aspects, the hardware encoders may be software-configurable hardware encoders. For example, the software configurations of the hardware encoders may be stored by storage 620.

In some non-limiting embodiments or aspects, storage 620 may include an NVMe SSD and/or the like. For example, storage 620 (e.g., NVMe SSD and/or the like) may include sufficient storage capacity and/or throughput capacity while also meeting other tolerance demands of an autonomous vehicle, such as low power consumption, noise tolerance, heat tolerance, and/or the like. In some non-limiting embodiments or aspects, storage 620 may store one or more sets of instructions (e.g., software code) configured to cause processor package 614 (e.g., multi-core processor 616 and/or chipset 618 thereof) to perform the functions described with respect thereto. Additionally or alternatively, storage 620 may store software configurations of the hardware encoders of multi-core processor 616, as described herein. For example, multi-core processor 616 may receive (e.g., via chipset 618) the instructions and/or software configurations from storage 620, which may cause multi-core processor 616 to encode the image data into the video streams, as described herein.

In some non-limiting embodiments or aspects, multi-core processor 616 may communicate at least one of the video streams to chipset 618 (e.g., via the OPIO connection), which may communicate at least one of the video streams to a data storage device and/or to a processor, which will in turn communicate and/or store the video stream(s), as described herein. For example, chipset 618 may communicate the video stream(s) via the PCIe connection to connector 612 (e.g., which may provide a connection to a first processor, as described herein). Additionally or alternatively, chipset 618 may communicate the video stream(s) to at least one network adapter 624, which may communicate the video streams(s) to connector 612 (e.g., which may provide a connection to a second processor, as described herein). In some non-limiting embodiments or aspects, chipset 618 may be connected to and/or communicate with first network adapter 624-1 via a high speed bus connection, such as a two-lane PCIe connection (e.g., PCIe 3×2) and/or the like. First network adapter 624-1 may include an Ethernet controller, which may receive the video stream(s) from chipset 618 via the high speed bus connection and communicate the video stream(s) via an Ethernet PHY connection (e.g., 10G Ethernet connection, such as a 10G baseband with backplane K medium and 64B/66B (R) coding scheme (10GBASE-KR) and/or the like) to connector 612. In some non-limiting embodiments or aspects, first network adapter 624-1 may be an Ethernet controller having sufficient throughput, while also meeting other tolerance demands of an autonomous vehicle, such as low power consumption, noise tolerance, heat tolerance, and/or the like. In some non-limiting embodiments or aspects, chipset 618 may be connected to and/or communicate with second network adapter 624-2 via a high speed bus connection, such as a one-lane PCIe connection (e.g., PCIe 3×1) and/or the like. Second network adapter 624-2 may include an Ethernet controller, which may receive other data (e.g., command and/or control data, metadata related to the video streams, and/or the like) from chipset 618 via the high speed bus connection and communicate the video stream(s) via an Ethernet MII connection (e.g., such as a serial gigabit MII (SGMII) connection and/or the like) to connector 612. In some non-limiting embodiments or aspects, second network adapter 624-2 may be an Ethernet controller having sufficient throughput, while also meeting other tolerance demands of an autonomous vehicle, such as low power consumption, noise tolerance, heat tolerance, and/or the like.

In some non-limiting embodiments or aspects, chipset 618 may be connected to and/or communicate with USB to UART converter 626 via a UART connection. Additionally or alternatively, USB to UART converter 626 may be connected to and/or communicate with connector 612 via a USB connection, such as a USB 3.1 connection and/or the like. For example, a USB connector of connector 612 may enable one or more processors of the autonomous vehicle to access debugging information. In some non-limiting embodiments or aspects, processor package 614 (e.g., chipset 618 thereof) may be connected to and/or communicate with debug connector 640 via a USB connection, such as a USB 3.1 connection and/or the like. For example, debug connector 640 may enable an external device to access debugging information. In some non-limiting embodiments or aspects, debug connector 640 may enable an external device to boot processor package 614, install and/or store software configurations (e.g., for the hardware encoders) in storage 620, install and/or store an operating system in storage 620, install and/or store instructions (e.g., software code to cause processor package 614 to perform the functions described with respect thereto) in storage 620, and/or the like. In some non-limiting embodiments or aspects, USB to UART converter 626 and/or debug connector 640 may be selected to provide access to debugging information and/or the other functionality described above, while also meeting other tolerance demands of an autonomous vehicle, such as power consumption (e.g., access to debugging information while powered down or only receiving standby power, ability to flash encoding device 606 and/or any components thereof while powered down or only receiving standby power, and/or the like), noise tolerance, heat tolerance, and/or the like.

In some non-limiting embodiments or aspects, ROM 628 may include at least one of an electrically erasable programmable read-only memory (EEPROM), a field replaceable unit (FRU) programmable read-only memory (PROM), an FRU EEPROM, any combination thereof, and/or the like. For example, ROM 628 may be an FRU EEPROM. In some non-limiting embodiments or aspects, ROM 628 may store data, such as serial presence detect (SPD) information, data related to the RAM of encoder device 606, data associated with a hardware version (e.g., of encoder device 606 and/or one or more components thereof), any combination thereof, and/or the like. In some non-limiting embodiments or aspects, ROM 628 may be connected to chipset 618 (e.g., the platform controller hub of processor package 614 and/or the like) via a system management bus (SMBus) connection (not pictured) or any other suitable connection (e.g., an inter-integrated circuit (I²C) connection and/or the like). In some non-limiting embodiments or aspects, ROM 628 may be connected to any other component of encoder device 606 via an SMBus connection or any other suitable connection (e.g., an I²C connection and/or the like).

In some non-limiting embodiments or aspects, clock 630 may include a real-time clock and/or the like. In some non-limiting embodiments or aspects, clock 630 may be connected to chipset 618 (e.g., the platform controller hub of processor package 614 and/or the like) via an SMBus connection (not pictured) or any other suitable connection (e.g., an I²C connection and/or the like). In some non-limiting embodiments or aspects, ROM 628 may be connected to any other component of encoder device 606 via an SMBus connection or any other suitable connection (e.g., an I²C connection and/or the like).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for video encoding for autonomous vehicles, comprising:
receiving, with at least one processor, image data associated with a plurality of images from at least one camera of an autonomous vehicle;
encoding, with the at least one processor, the image data into a plurality of video streams comprising at least one first video stream and at least one second video stream, the at least one first video stream associated with a first quality level, the at least one second video stream associated with a second quality level different than the first quality level; and
communicating, with the at least one processor, at least one of the plurality of video streams to at least one data storage device.

2. The method of claim 1, wherein the at least one camera comprises at least one near field camera and at least one far field camera, and wherein receiving the image data comprises:
receiving, with at least one first image signal processor (ISP), first image data from each respective far field camera of the at least one far field camera;
communicating, with the at least one first ISP, the first image data from each respective far field camera to at least one graphics processor;
receiving, with at least one second ISP, second image data from each respective near field camera of the at least one near field camera;
communicating, with the at least one second ISP, the second image data from each respective near field camera to the at least one graphics processor;
preprocessing, with the at least one graphics processor, at least one of the first image data, the second image data, or any combination thereof to form the image data; and
communicating, by the at least one graphics processor, the image data to the at least one processor.

3. The method of claim 2, wherein preprocessing comprises at least one of:
reducing, with the at least one graphics processor, a resolution of the at least one of the first image data, the second image data, or any combination thereof;
modifying, with the at least one graphics processor, a color format of the at least one of the first image data, the second image data, or any combination thereof; or
any combination thereof.

4. The method of claim 1, wherein the at least one camera comprises a first camera and a second camera,
wherein the image data comprises first image data associated with a first plurality of images from the first camera and second image data associated with a second plurality of images from the second camera,
wherein receiving the image data comprises:
receiving the first image data associated with a first image of the first plurality of images from the first camera;
storing the first image data associated with the first image in a data storage device;
receiving the second image data associated with a second image of the second plurality of images from the second camera after receiving the first image data associated with the first image; and
storing the second image data associated with the second image in the data storage device, and
wherein encoding comprises encoding the first image data associated with the first image before encoding the second image data associated with the second image.

5. The method of claim 1, wherein encoding comprises encoding the image data into the plurality of video streams in real time during operation of the autonomous vehicle.

6. The method of claim 1, wherein encoding comprises encoding the image data into the plurality of video streams substantially simultaneously.

7. The method of claim 1, wherein the at least one processor comprises a plurality of hardware encoders comprising a first hardware encoder and a second hardware encoder.

8. The method of claim 7, wherein encoding the image data comprises encoding the image data into the at least one first video stream with the first hardware encoder and encoding the image data into the at least one second video stream with the second hardware encoder.

9. The method of claim 7, wherein the first hardware encoder encodes the image data into the first video stream independent of the second hardware encoder encoding the image data into the at least one second video stream.

10. The method of claim 7, wherein the first hardware encoder comprises a first software-configurable hardware encoder and the second hardware encoder comprises a second software-configurable hardware encoder, wherein the first software-configurable hardware encoder encodes the image data into one of the at least one first video stream or the at least one second video stream based on a first software configuration of the first software-configurable hardware encoder, and wherein the second software-configurable hardware encoder encodes the image data into one of the at least one first video stream or the at least one second video stream based on a second software configuration of the second software-configurable hardware encoder.

11. The method of claim 1, wherein communicating the at least one of the plurality of video streams to the at least one data storage device comprises:
communicating, with the at least one processor, the at least one of the plurality of video streams to a central processing unit; and
storing, with the central processing unit, the at least one of the plurality of video streams in the at least one data storage device.

12. The method of claim 1, wherein communicating the at least one of the plurality of video streams to the at least one data storage device comprises:
storing, with the at least one processor, the at least one first video stream in a first data storage device of the autonomous vehicle; and
communicating, with the at least one processor, the at least one second video stream to a remote system via a communication network during operation of the autonomous vehicle, wherein the remote system stores the at least one second video stream in a second data storage device of the remote system.

13. The method of claim 12, wherein communicating the at least one of the plurality of video streams to the at least one data storage device further comprises:
communicating, with the at least one processor, the at least one first video stream from the first data storage device to the remote system after ceasing operation of the autonomous vehicle.

14. The method of claim 1, further comprising:
facilitating at least one autonomous driving operation of the autonomous vehicle based on the at least one of the plurality of video streams.

15. A system for video encoding for autonomous vehicles, comprising:
at least one camera of an autonomous vehicle; and
an encoder device configured to:
receive image data associated with a plurality of images from the at least one camera;
encode the image data into a plurality of video streams comprising at least one first video stream and at least one second video stream, the at least one first video stream associated with a first quality level, the at least one second video stream associated with a second quality level different than the first quality level; and
communicate at least one of the plurality of video streams to at least one data storage device.

16. The system of claim 15, wherein the at least one camera comprises at least one near field camera and at least one far field camera, the system further comprises:
at least one graphics processor;
at least one first image signal processor (ISP) configured to receive first image data from each respective far field camera of the at least one far field camera and communicate the first image data from each respective far field camera to the at least one graphics processor; and
at least one second ISP configured to receive second image data from each respective near field camera of the at least one near field camera and communicate the second image data from each respective near field camera to the at least one graphics processor,
wherein the at least one graphics processor is configured to preprocess at least one of the first image data, the second image data, or any combination thereof to form the image data and communicate the image data to the encoder device,
wherein preprocessing comprises at least one of:
reducing, with the at least one graphics processor, a resolution of the at least one of the first image data, the second image data, or any combination thereof;
modifying, with the at least one graphics processor, a color format of the at least one of the first image data, the second image data, or any combination thereof; or
any combination thereof.

17. The system of claim 15, wherein the at least one camera comprises a first camera and a second camera, wherein the image data comprises first image data associated with a first plurality of images from the first camera and second image data associated with a second plurality of images from the second camera, wherein the encoder device further comprises a data storage device configured to:
store the first image data associated with a first image of the first plurality of images from the first camera; and
store the second image data associated with a second image of the second plurality of images from the second camera after receiving the first image data associated with the first image,
wherein the encoder device is configured to encode the first image data associated with the first image before encoding the second image data associated with the second image.

18. The system of claim 15, further comprising a computing device of the autonomous vehicle, wherein the computing device comprises a central processing unit and a data storage device, wherein, when communicating the at least one of the plurality of video streams to the at least one data storage device, the encoder device is configured to communicate the at least one of the plurality of video streams to the central processing unit, and wherein the central processing unit is configured to store the at least one of the plurality of video streams in the data storage device.

19. The system of claim 15, wherein, when communicating the at least one of the plurality of video streams to the at least one data storage device, the encoder device is configured to:
store the at least one first video stream in a first data storage device of the autonomous vehicle; and
communicate the at least one second video stream to a remote system via a communication network during operation of the autonomous vehicle, wherein the remote system stores the at least one second video stream in a second data storage device of the remote system.

20. A computer program product for video encoding for autonomous vehicles, comprising at least one non-transitory computer-readable medium comprising one or more instructions that, when executed by at least one processor, cause the at least one processor to:
receive image data associated with a plurality of images from at least one camera of an autonomous vehicle;
encode the image data into a plurality of video streams comprising at least one first video stream and at least one second video stream, the at least one first video stream associated with a first quality level, the at least one second video stream associated with a second quality level different than the first quality level; and
communicate at least one of the plurality of video streams to at least one data storage device.
